(19) United States
(12) Patent Application Publication
(10) Pub. No.: US 2025/0245980 A1
(43) Pub. Date: Jul. 31, 2025

(54) ESTIMATION DEVICE, ESTIMATION METHOD, STORAGE MEDIUM, VEHICLE CONTROL DEVICE, AND VEHICLE

(71) Applicant: HONDA MOTOR CO., LTD., Tokyo (JP)

(72) Inventors: Srinivasa divakar Bhat, Wako-shi (JP); Amit popat More, Wako-shi (JP)

(21) Appl. No.: 19/011,801

(22) Filed: Jan. 7, 2025

(30) Foreign Application Priority Data
Jan. 31, 2024 (JP) 2024-012900

(51) Int. Cl. G06V 10/98; G06V 10/75

(52) U.S. Cl. CPC G06V 10/98; G06V 10/751

(57) ABSTRACT

An estimation device includes a storage medium configured to store computer-readable instructions, and a processor connected to the storage medium, in which the processor executes the computer-readable instructions to acquire, with data as an input, a logit that at least a portion of the data corresponds to a class that represents a certain type by inputting target data to a machine learning model learned to output the logit, calculate a correction value for correcting the logit using an output of the machine learning model, correct the logit on the basis of the calculated correction value, and estimate a class to which at least a portion of the target data corresponds on the basis of the corrected logit.

### CROSS-REFERENCE TO RELATED APPLICATION

Priority is claimed on Japanese Patent Application No. 2024-012900, filed Jan. 31, 2024, the content of which is incorporated herein by reference.

### BACKGROUND

### Field of the Invention

The present invention relates to an estimation device, an estimation method, a storage medium, a vehicle control device, and a vehicle.

### Description of Related Art

Conventionally, in learning of a machine learning model that uses an image as an input and classifies a type of an object contained in the image into classes, a technology is known that prevents a decrease in estimation accuracy of the model due to an imbalance between classes in terms of the number of items of teacher data (samples).

For example, Menon et al., “Long-tail learning via logit adjustment”, describes a technology for correcting a weight of an error function used in the learning (a weight of the error function corresponding to each class) and a logit (an output value of the machine learning model) according to the number of samples corresponding to each class.

The technology described in Menon et al., “Long-tail learning via logit adjustment,” corrects the logit using the number of samples in the entire teacher data and the number of samples in each class. However, with such a simple method, the logit is not corrected with high accuracy, and as a result, the accuracy of a generated machine learning model may be low in some cases.

### SUMMARY

The present invention has been made in consideration of the circumstances described above, and one of its objects is to provide an estimation device, an estimation method, a storage medium, a vehicle control device, and a vehicle that can improve the accuracy of a generated machine learning model by correcting the logit output by the machine learning model with high accuracy.

The estimation device, estimation method, storage medium, vehicle control device, and vehicle according to the present invention adopt the following configuration.

(1): An estimation device according to one aspect of the present invention includes a storage medium configured to store computer-readable instructions, and a processor connected to the storage medium, in which the processor executes the computer-readable instructions to acquire, with data as an input, a logit that at least a portion of the data corresponds to a class that represents a certain type by inputting target data to a machine learning model learned to output the logit, calculate a correction value for correcting the logit using an output of the machine learning model, correct the logit on the basis of the calculated correction value, and estimate a class to which at least a portion of the target data corresponds on the basis of the corrected logit.

(2): In the aspect of (1) described above, the processor may calculate the correction value using a preset hyperparameter and an output of the machine learning model.

(3): In the aspect of (2) described above, the processor may calculate the correction value by a product of the hyperparameter and a prior probability of occurrence of a sample of the class, which is calculated from a marginal distribution defined by the machine learning model.

(4): In the aspect of (1) described above, the processor may correct the logit by adding the correction value to the logit, and estimate a class where a probability value is maximized based on the corrected logit as the class to which at least a portion of the target data corresponds.

(5): In the aspect of (1) described above, the data may be an image including a plurality of pixels, and at least a portion of the data may be one or more pixel groups of the image.

(6): In the aspect of (1) described above, the data may be a vocal sound, and at least a portion of the data may be a section of the vocal sound.

(7): A vehicle control device according to another aspect of the present invention includes the estimation device according to (1), in which the processor controls traveling of a vehicle on the basis of a result of estimation by the estimation device.

(8): A vehicle according to still another aspect of the present invention includes the vehicle control device according to (7).

(9): An estimation method according to still another aspect of the present invention includes, by a computer, acquiring, with data as an input, a logit that at least a portion of the data corresponds to a class that represents a certain type by inputting target data to a machine learning model learned to output the logit, calculating a correction value for correcting the logit using an output of the machine learning model, correcting the logit on the basis of the calculated correction value, and estimating a class to which at least a portion of the target data corresponds on the basis of the corrected logit.

(10): A computer-readable non-transitory storage medium according to still another aspect of the present invention stores a program causing a computer to execute acquiring, with data as an input, a logit that at least a portion of the data corresponds to a class that represents a certain type by inputting target data to a machine learning model learned to output the logit, calculating a correction value for correcting the logit using an output of the machine learning model, correcting the logit on the basis of the calculated correction value, and estimating a class to which at least a portion of the target data corresponds on the basis of the corrected logit.

According to the aspects of (1) to (10), it is possible to improve accuracy of a generated machine learning model by correcting logit output by the machine learning model with high accuracy.

### BRIEF DESCRIPTION OF THE DRAWINGS

FIG. 1 is a diagram which shows a configuration of an estimation device according to a first embodiment.

FIG. 2 is a diagram which shows an example of a configuration of learning data.

FIG. 3 is a diagram for describing an overview of machine learning that generates a machine learning model on the basis of learning data.

FIG. 4 is a flowchart which shows an example of a flow of processing executed by the estimation device according to the first embodiment.

FIG. 5 is a diagram which shows a configuration of an estimation device according to a second embodiment.

FIG. 6 is a flowchart which shows an example of a flow of processing executed by the estimation device according to the second embodiment.

FIG. 7 is a diagram which shows a configuration of a host vehicle equipped with a vehicle control device including the estimation device.

### DESCRIPTION OF EMBODIMENTS

### First Embodiment

Hereinafter, embodiments of an estimation device, an estimation method, a storage medium, a vehicle control device, and a vehicle of the present invention will be described with reference to the drawings.

### Configuration

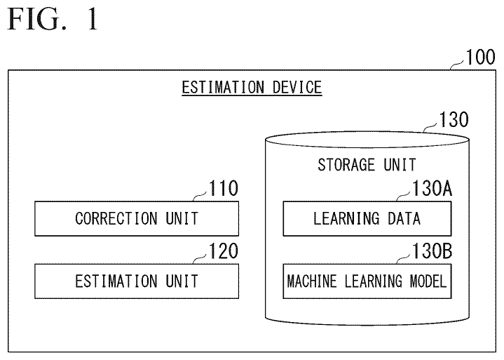

FIG. 1 is a diagram which shows a configuration of an estimation device 100 according to a first embodiment. The estimation device 100 is an information processing device that estimates a type of one or more pixel groups by using a machine learning model that is learned to, with an image including a plurality of pixels as an input, output a logit that one or more pixel groups of the image correspond to a class that represents a type of an object. The estimation device 100 includes, for example, a correction unit 110, an estimation unit 120, and a storage unit 130. The correction unit 110 and the estimation unit 120 are each realized by, for example, a hardware processor such as a central processing unit (CPU) executing a program (software). In addition, some or all of these components may be realized by hardware (a circuit unit; including circuitry) such as a large scale integration (LSI), an application specific integrated circuit (ASIC), a field programmable gate array (FPGA), a graphics processing unit (GPU), or a system on chip (SOC), or may be realized by cooperation between software and hardware. The program may be stored in advance in a storage device (a storage device having a non-transient storage medium) such as an HDD or flash memory of the estimation device 100, or may be stored in a removable storage medium such as a DVD or CD-ROM and may be installed in the HDD or flash memory of the estimation device 100 by the storage medium (non-transient storage medium) being attached to a drive device. The storage unit 130 stores, for example, learning data 130A and a machine learning model 130B. The storage unit 130 is realized, for example, by a RAM, a flash memory, an SD card, and the like.

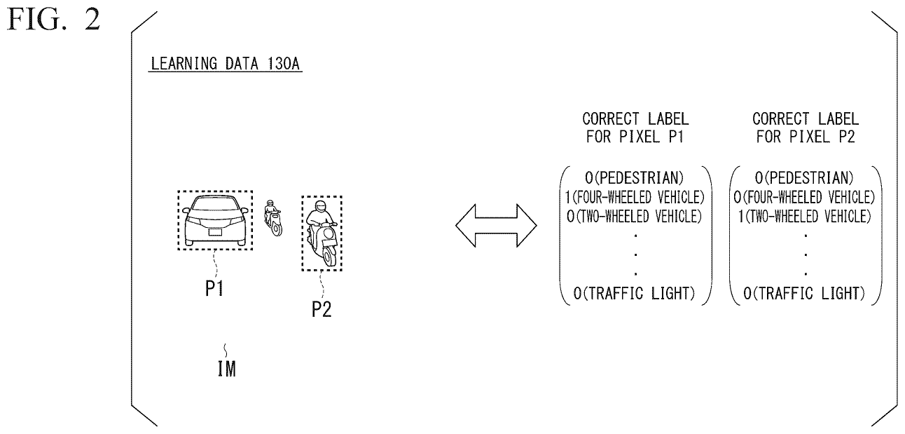

FIG. 2 is a diagram which shows an example of a configuration of the learning data 130A. The learning data 130A is result of associating, for example, one or more pixel groups of an image IM with a class representing a type of an object represented by a corresponding pixel group as a correct class. Here, the “type of an object” is a type of an object related to a surrounding environment of a vehicle, and includes at least two of a four-wheeled vehicle, a two-wheeled vehicle, a pedestrian, a fallen object, a traffic light, a road sign, a guardrail, a median strip, and a curb. In addition, the “type of an object” may be limited to moving objects, and at least two of a four-wheeled vehicle, a two-wheeled vehicle, and a pedestrian may be defined as the type of an object.

For example, in a case of FIG. 2, the image IM includes a pixel group P1 representing a four-wheeled vehicle and a pixel group P2 representing a two-wheeled vehicle. At this time, for example, the pixel group P1 is associated with a vector in which only a component of a class representing a four-wheeled vehicle is set to 1 and components of other classes are set to 0, thereby acquiring learning data 130A (hereinafter sometimes referred to as a sample) in which the four-wheeled vehicle class is set to a correct class. In addition, for example, the pixel group P2 is associated with a vector in which only a component of a class representing a two-wheeled vehicle is set to 1 and components of other classes are set to 0, thereby acquiring learning data 130A in which the two-wheeled vehicle class is set to a correct class. The storage unit 130 stores a corresponding relationship between these pixel groups and the correct classes as the learning data 130A.

The learning data 130A is generated by, for example, an administrator or operator of the estimation device 100 specifying each pixel of the image IM and the correct class in advance on his or her own terminal, and is stored in the storage unit 130. Alternatively, the estimation device 100 may download the learning data 130A stored in an external server to the storage unit 130 via a network when learning is executed.

The machine learning model 130B is a machine learning model that takes an image including a plurality of pixels as an input and outputs logit (likelihood) that one or more pixel groups in the image correspond to a class that represents a type of an object. Here, logit is a value that correlates with a probability that a pixel group of the image IM corresponds to the class that represents a type of an object. The machine learning model 130B is, for example, a convolutional neural network (CNN), which extracts features of an input pixel to output a logit that the pixel corresponds to each class.

### [Overview of Machine Learning]

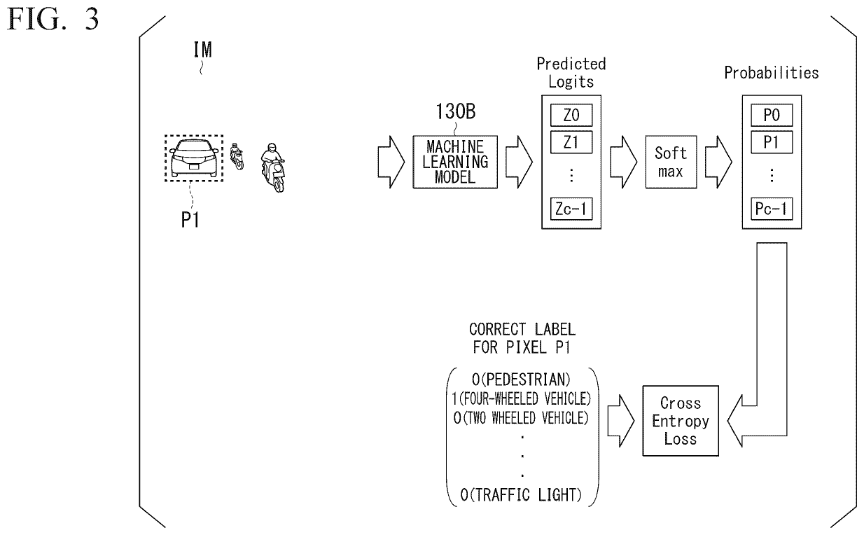

FIG. 3 is a diagram for describing an overview of machine learning that generates a machine learning model 130B on the basis of the learning data 130A. In FIG. 3, C represents a total number of classes to be classified, and Z₀ to Z_{C-1} represent logits output by the machine learning model 130B. As shown in FIG. 3, each output logit is converted into a probability value P₀ to P_{C-1} normalized to a value between 0 and 1 by substituting it into a softmax function, and an error between the converted probability value and a correct vector is calculated using an error function L such as a cross-entropy error, and the machine learning model 130B is learned using, for example, a method such as an error backpropagation method to minimize the calculated error.

In the present embodiment, as an example, a multi-value class classification of pixels included in an image is described, so that the softmax function is applied in FIG. 3. However, the present invention is not limited to such a configuration, and when binary classification of pixels included in an image is performed, a sigmoid function may be applied instead of the softmax function in FIG. 3. Furthermore, in that case, a cross-entropy error L may be calculated as a binary cross-entropy error L instead of the softmax cross-entropy error.

The machine learning model 130B learned as described above does not take into account an imbalance between classes in terms of the number of samples in the learning data 130A prepared for each class. As a result, the machine learning model 130B is learned in a learning process so that a class with a larger number of samples tends to output a higher logit, that is, a higher probability value, and the estimation accuracy of the model may decrease in some cases.

### [Correction by Correction Unit 110]

In light of this, the correction unit 110 adds correction terms Δ₀ to Δ_{C-1} to logits Z₀ to Z_{C-1} output by the machine learning model 130B that has completed learning, respectively, to calculate corrected logits Z′₀ to Z′_{C-1}. The estimation unit 120 calculates corrected probability values P′₀ to P′_{C-1} by substituting the correction logits Z′₀ to Z′_{C-1} into the softmax function in place of the logits Z₀ to Z_{C-1} in an estimation stage. The estimation unit 120 estimates the class corresponding to the highest probability value among the calculated probability values P′₀ to P′_{C-1} as an object included in the input image.

More specifically, the correction unit 110 calculates the correction logit Z′ᵢ (i is any integer between 0 and C−1) according to the following equation (1).

$${Z}_{i}^{′} = {Z}_{i} - α log P ( {y}_{i} ) \qquad ( 1 )$$

In Equation (1), a represents a hyperparameter that is set in advance, and P(yᵢ) represents a prior probability that a sample of class i occurs among all samples of the learning data 130A. The hyperparameter a is tuned using validation data that is different from the learning data 130A when the correction logit Z′ᵢ is calculated. When P(x, y) is a joint probability, P(y) is calculated according to the following equation (2).

$$\begin{matrix}[ Math . 1 ] & \\ \begin{matrix}P ( \text{?} ) = \int P ( x , y ) dx \\ = \int P ( y \vert x ) P ( \text{?} ) d \text{?} \\ \approx \frac{1}{N} \text{?} P ( y \vert \text{?} )\end{matrix} & ( 2 )\end{matrix}$$

$$\text{?} \text{indicates text missing or illegible when filed}$$

In Equation (2), P(y|x) represents a conditional probability that a sample of class y occurs, assuming that a sample of class x (x represents any class other than class y in the learning data 130A) occurs, and can be calculated using an output of the learned machine learning model 130B (more specifically, marginal distribution defined by the probability values P₀ to P_{C-1} output via the learned machine learning model 130B).

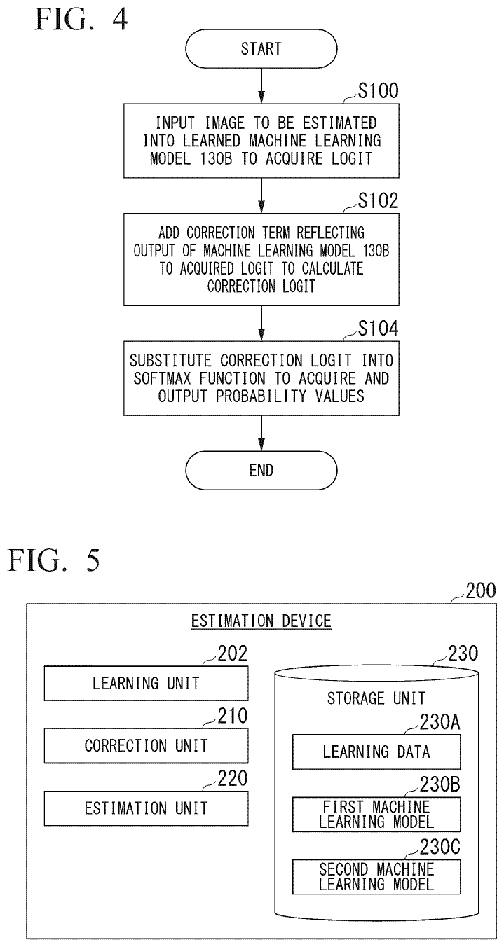

Next, a flow of processing executed by the estimation device 100 according to the first embodiment will be described with reference to FIG. 4. FIG. 4 is a flowchart which shows an example of the flow of processing executed by the estimation device 100 according to the first embodiment.

First, the correction unit 110 inputs an image to be estimated into the learned machine learning model 130B to acquire logits Z₀ to Z_{C-1} (step S100). Next, the correction unit 110 adds a correction term Δi=−α log P(yᵢ) reflecting the output of the machine learning model 130B to the acquired logits Z₀ to Z_{C-1} to calculate the correction logits Z′₀ to Z′_{C-1} (step S102). Next, the estimation unit 120 substitutes the correction logits Z′₀ to Z′_{C-1} into a softmax function to acquire and output the corrected probability values P′₀ to P′_{C-1} (step S104). This completes processing of this flowchart.

According to the first embodiment described above, unlike a technology described in Non-Patent Document 1, which simply calculates a correction term by performing addition, subtraction, multiplication, and division between the number of samples in an entire teacher data and the number of samples in each class, a prior probability P(yᵢ) in the correction term Δi=−α log P(yᵢ) in Equation (1) is calculated using the output of the learned machine learning model 130B. That is, according to the first embodiment, logit is corrected with higher accuracy, and accuracy of the generated machine learning model can be improved.

### Second Embodiment

The first embodiment prevents a decrease in the estimation accuracy of the model caused by an imbalance between classes in terms of the number of samples by adding a correction term calculated using the output of the machine learning model 130B to the logit output by the learned machine learning model 130B. As a second embodiment, in a learning process of the machine learning model 130B, the machine learning model 130B may be re-learned using an error function L corrected on the basis of the output of the machine learning model 130B once learned to prevent a decrease in the estimation accuracy of the model.

FIG. 5 is a diagram which shows a configuration of an estimation device 200 according to the second embodiment. As in the first embodiment, the estimation device 200 is an information processing device that receives an image including a plurality of pixels as input, and estimates types of one or more pixel groups using a machine learning model that has been learned to output a logit that the one or more pixel groups in the image correspond to a class that represents a type of an object. The estimation device 200 includes, for example, a learning unit 202, a correction unit 210, an estimation unit 220, and a storage unit 230. The learning unit 202, the correction unit 210, and the estimation unit 220 are each realized by, for example, a hardware processor such as a central processing unit (CPU) executing a program (software). In addition, some or all of these components may be realized by hardware (a circuit unit; including circuitry) such as a large scale integration (LSI), an application specific integrated circuit (ASIC), a field-programmable gate array (FPGA), a graphics processing unit (GPU), or a system on chip (SoC), or may be realized by software and hardware in cooperation. The program may be stored in advance in a storage device (a storage device having a non-transient storage medium) such as the HDD or flash memory of the estimation device 100, or may be stored in a removable storage medium such as a DVD or CD-ROM, and may be installed in an HDD or flash memory of the estimation device 200 by mounting the storage medium (a non-transient storage medium) in a drive device. The storage unit 230 stores, for example, learning data 230A, a first machine learning model 230B, and a second machine learning model 230C. The storage unit 230 is realized by, for example, a RAM, a flash memory, an SD card, or the like. Configurations of the correction unit 210 and the estimation unit 220 according to the second embodiment are similar to the configurations of the correction unit 110 and the estimation unit 120 according to the first embodiment, respectively, and therefore descriptions thereof will be omitted. The learning unit 202 is an example of a “learning device” in the claims. An image including a plurality of pixels is an example of “data” in the claims, and one or more pixel groups of the image are an example of “at least a portion of data” in the claims.

First, the learning unit 202 generates the first machine learning model 230B by learning a machine learning model such as a convolutional neural network on the basis of the learning data 130A, similar to the machine learning described in FIG. 3. The generated first machine learning model 230B is the same as the learned machine learning model 130B in the first embodiment. Next, as in the first embodiment, the learning unit 202 uses an output of the learned first machine learning model 230B (more specifically, a marginal distribution defined by the probability values P₀ to P_{C-1} output via the learned first machine learning model 230B) to calculate the prior probability P(yᵢ) that a sample of class i occurs among all samples of the learning data 130A.

Next, the correction unit 210 uses the calculated prior probability P(yᵢ) to correct an error function representing a general cross-entropy error according to the following equation (3), thereby redefining and calculating the error function L. In Equation (3), k represents all integers from 0 to C−1.

$$\begin{matrix}[ Math . 2 ] & \\ L = - log \frac{{e}^{{z}_{i} + a log P ( {y}_{i} )}}{{\sum }_{k}^{C} {e}^{{z}_{k} + α log P ( {y}_{k} )}} & ( 3 )\end{matrix}$$

Alternatively, the correction unit 210 may redefine and calculate the error function L according to the following equation (4), which adds an entropy regularization term to Equation (3) to increase an entropy of the first machine learning model 230B. By adding the entropy regularization term to the error function L, the re-learning of the first machine learning model 230B is performed while maintaining a high entropy, and it is possible to prevent generation of a model that is biased toward the estimation of a specific class (that is, a class with a large amount of learning data 130A).

$$\begin{matrix}[ Math . 3 ] & \\ L = - log \frac{\text{?}}{\text{?}} + \text{?} ε ( \text{?} ) & ( 4 )\end{matrix}$$

$$\text{?} \text{indicates text missing or illegible when filed}$$

In Equation (4), λ is a hyperparameter that is set in advance, and bᵢ is a bias term with an initial value log P(yᵢ), both of which are adjusted during the re-learning process. The hyperparameter λ defines a degree of an influence of an entropy regularization term ε(z). The bias term bᵢ is for preventing mismatch between empirical distribution defined by the learning data 130A and prior distribution estimated by the model from expanding due to the re-learning of the first machine learning model 230B, which is caused by the addition of the entropy regularization term. The entropy regularization term ε(z) is calculated, for example, according to the following equation (5).

$$\begin{matrix}[ Math . 4 ] & \\ ε ( z ) = \frac{{e}^{{z}_{i}}}{\text{?} {e}^{{z}_{k}}} log ( \frac{{e}^{{z}_{i}}}{\text{?} {e}^{{z}_{k}}} ) & ( 5 )\end{matrix}$$

$$\text{?} \text{indicates text missing or illegible when filed}$$

When the correction unit 210 corrects the error function L, the learning unit 202 uses the redefined error function L to re-learn the first machine learning model 230B, thereby generating the second machine learning model 130C. The re-learning at this time may be learning of the entire first machine learning model 230B, or may be learning of a part of it. Here, learning a portion refers to fine-tuning a classification layer of the first machine learning model 230B, and the classification layer refers to the last several layers (for example, 2 layers or 3 layers) of the first machine learning model 230B, counting from an output side.

In the estimation stage, the estimation unit 220 inputs an image to be estimated into the second machine learning model 130C to acquire logits Z″₀ to Z″_{C-1}, and substitutes the acquired logits Z″₀ to Z″_{C-1} into the softmax function to acquire and output probability values P″₀ to P″_{C-1}. At this time, the correction unit 210 may use the acquired logit Z″ᵢ and the second machine learning model 130C to calculate the correction term Δj described in the first embodiment, and correct the logit Z″ᵢ by adding the correction term Δj to the logit Z″ᵢ. In this manner, according to the present invention, the estimation accuracy of the model can be further improved by combining correction of the correction term described in the first embodiment and re-learning described in the second embodiment.

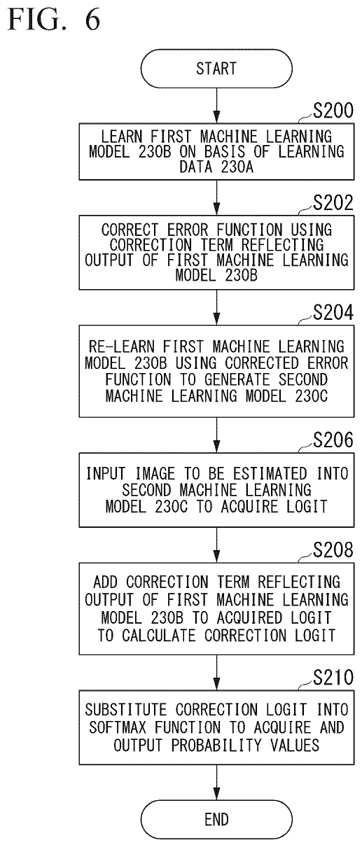

Next, referring to FIG. 6, a flow of processing executed by the estimation device 200 according to the second embodiment will be described. FIG. 6 is a flowchart which shows an example of the flow of processing executed by the estimation device 200 according to the second embodiment.

First, the learning unit 202 learns the first machine learning model 230B on the basis of the learning data 230A (step S200). Next, the correction unit 210 corrects the error function using a correction term reflecting the output of the first machine learning model 230B (step S202). Next, the learning unit 202 re-learns the first machine learning model 230B using the corrected error function to generate the second machine learning model 130C (step S204).

Next, the estimation unit 220 inputs the image to be estimated into the second machine learning model 230C to acquire the logits Z″₀ to Z″_{C-1} (step S206). Next, the correction unit 110 adds the correction term Δi reflecting the output of the first machine learning model 230B to the acquired logits Z″₀ to Z″_{C-1} to calculate the correction logits Z″₀ to Z″_{C-1} (step S208). Next, the estimation unit 120 substitutes the correction logits Z′″₀ to Z″_{C-1} into the softmax function to acquire and output the corrected probability values P″₀ to P″_{C-1} (step S210). As a result, processing of this flowchart ends.

According to the second embodiment described above, the error function L representing a cross-entropy error shown by Equation (3) is calculated using the output of the learned first machine learning model 230B. That is, according to the second embodiment, the error function L used to learn the machine learning model is corrected with high accuracy, and the accuracy of the generated machine learning model can be improved.

In the embodiment described above, the machine learning model is configured and learned to input an image and output a logit of the type of an object indicated by a pixel group of the image. However, the present invention is not limited to such a configuration, and can also be applied to a case where the machine learning model is configured and learned to input other types of data (for example, vocal sound) and output a logit of a type of the data. For example, the machine learning model may be configured and learned to input a vocal sound and output the logit of the type indicated by a section of the vocal sound. Even if the data being handled is of a type other than an image, as long as the machine learning model is configured to output at least logit, logit correction processing by the correction unit 110 (210) described above can be similarly applied. Vocal sound is another example of “data” in the claims, and a vocal sound section is another example of “at least a part of the data” in the claims.

### [Vehicle]

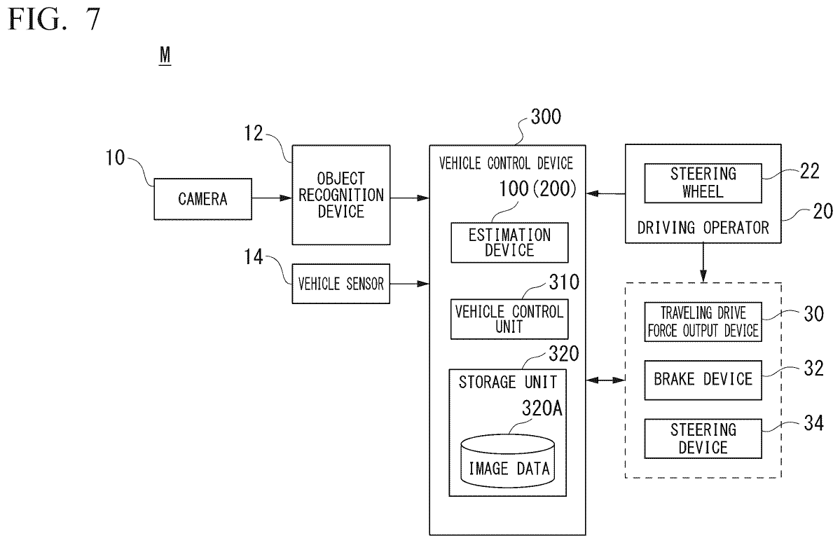

The estimation device 100 (200) described above may be mounted on a vehicle control device and used to control a host vehicle M. FIG. 7 shows a configuration of the host vehicle M equipped with a vehicle control device 300 including an estimation device.

The host vehicle M includes, for example, a camera 10, an object recognition device 12, a vehicle sensor 14, a driving operator 20, a steering wheel 22, a traveling drive force output device 30, a brake device 32, a steering device 34, and a vehicle control device 300.

The camera 10 is, for example, a digital camera using a solid-state image sensor such as a charge coupled device (CCD) or a complementary metal oxide semiconductor (CMOS). The camera 10 is attached to any place of the host vehicle M. When an image of the front is captured, the camera 10 is attached to a top of the front windshield or a back of the rearview mirror. The camera 10, for example, periodically captures images of surroundings of the host vehicle M. The camera 10 may be a stereo camera. The camera 10 transmits the captured images to the object recognition device 12.

The object recognition device 12 detects pedestrians, other vehicles, road structures (such as road dividing lines and walls) and the like reflected in an image received from the camera 10 by performing image processing on the image, and transmits results of the detection to the vehicle control device 300. In this case, the detection results are the recognized objects identified as pixel groups, as described with reference to FIG. 2.

The vehicle sensor 14 includes a vehicle speed sensor that detects a speed of the host vehicle M, an acceleration sensor that detects the acceleration, a yaw rate sensor that detects the angular speed around a vertical axis, and a direction sensor that detects an orientation of the host vehicle M.

The driving operators 20 include, for example, in addition to a steering wheel 22, an accelerator pedal, a brake pedal, a shift lever, and other operators. The driving operators 20 are attached to sensors that detect an amount of operation or presence or absence of an operation, and the detection results are output to the vehicle control device 300, or some or all of the traveling drive force output device 30, the brake device 32, and the steering device 34. The operators do not necessarily have to be annular, and may be in a form of irregular steering, a joystick, or a button.

The traveling drive force output device 30 outputs a traveling drive force (torque) for the host vehicle M to travel to the drive wheels. The traveling drive force output device 30 includes, for example, a combination of an internal combustion engine, an electric motor, and a transmission, and an electronic control unit (ECU) that controls these. The ECU controls the configuration described above according to information input from the vehicle control device 300 or information input from the driving operators 20.

The brake device 32 includes, for example, a brake caliper, a cylinder that transmits hydraulic pressure to the brake caliper, an electric motor that generates hydraulic pressure in the cylinder, and a brake ECU. The brake ECU controls an electric motor according to information input from the vehicle control device 300 or information input from the driving operator 20, so that a brake torque corresponding to the braking operation is output to each wheel. The brake device 32 may include a backup mechanism that transmits hydraulic pressure generated by operating a brake pedal included in the driving operator 20 to a cylinder via a master cylinder. Note that the brake device 32 is not limited to the configuration described above, and may be an electronically controlled hydraulic brake device that controls an actuator according to the information input from the vehicle control device 300 to transmit hydraulic pressure of the master cylinder to the cylinder.

The steering device 34 includes, for example, a steering ECU and an electric motor. The electric motor applies, for example, a force to a rack and pinion mechanism to change the direction of the steered wheels. The steering ECU drives the electric motor and changes a direction of the steering wheels according to the information input from the vehicle control device 300 or information input from the driving operator 20.

The vehicle control device 300 includes, for example, an estimation device 100 (200) and a vehicle control unit 310. The vehicle control unit 310 is realized, for example, by a hardware processor such as a central processing unit (CPU) executing a program (software). In addition, some or all of these components may be realized by hardware (including circuitry) such as a large scale integration (LSI), an application specific integrated circuit (ASIC), a field-programmable gate array (FPGA), or an graphics processing unit (GPU), or may be realized by software and hardware in cooperation. The program may be stored in advance in a storage device (a storage device with a non-transient storage medium) such as an HDD or flash memory of the vehicle control device 300, or may be stored in a removable storage medium such as a DVD or CD-ROM, and may be installed in the HDD or flash memory of the vehicle control device 300 by the storage medium (non-transient storage medium) being attached to a drive device. The storage unit 320 is realized by, for example, a read only memory (ROM), a flash memory, an SD card, a random access memory (RAM), a register, or the like. The storage unit 320 stores an image including a result of recognizing an object received from the object recognition device 12 as image data 320A.

The estimation device 100 (200) uses the estimation unit 120 (220) to estimate the type of an object corresponding to a pixel group included in the image data 320A. More specifically, the estimation device 100 (200) estimates the type that has the maximum value among the probability values output for the pixel group included in the image data 320A as the type of an object corresponding to the pixel group.

The vehicle control unit 310 controls the traveling of the host vehicle M by controlling at least one of the traveling drive force output device 30, the brake device 32, and the steering device 34 on the basis of a result of the estimation by the estimation device 100 (200). More specifically, for example, when the type of an object estimated by the estimation device 100 (200) corresponds to any one of four-wheeled vehicles, two-wheeled vehicles, pedestrians, and fallen objects, the vehicle control unit 310 controls the traveling of the host vehicle M to avoid the object. Also, for example, when the type of an object estimated by the estimation device 100 (200) corresponds to a traffic light or a road sign, the vehicle control unit 310 controls the traveling of the host vehicle M according to instruction information indicated by the traffic light or road sign (for example, when the instruction information indicated by the traffic light is recognized as a stop (red), the host vehicle M is slowed down or stopped). In addition, for example, when the type of an object estimated by the estimation device 100 (200) corresponds to a guardrail, a median strip, or a curb, the vehicle control unit 310 controls the host vehicle M to travel along the object.

In another aspect, the vehicle control unit 310 may display the type of an object estimated by the estimation device 100 (200) on a display mounted in the host vehicle M, without actually controlling the host vehicle M. In other words, the vehicle control unit 310 may function as a driving assistance unit.

The embodiment described above can be expressed as follows.

An estimation device includes a storage medium (storage medium/memory) for storing computer-readable instructions, and a processor connected to the storage medium, in which the processor executes the computer-readable instructions to acquire, with data as an input, a logit that at least a portion of the data corresponds to a class that represents a certain type by inputting target data to a machine learning model learned to output the logit, calculate a correction value for correcting the logit using an output of the machine learning model, correct the logit on the basis of the calculated correction value, and estimate a class to which at least a portion of the target data corresponds on the basis of the corrected logit.

Although a mode for carrying out the present invention has been described above using the embodiment, the present invention is not limited to the embodiment, and various modifications and substitutions can be made within a range not departing from the gist of the present invention.

What is claimed is:

1. An estimation device comprising:
a storage medium configured to store computer-readable instructions; and
a processor connected to the storage medium,
wherein the processor executes the computer-readable instructions to acquire, with data as an input, a logit that at least a portion of the data corresponds to a class that represents a certain type by inputting target data to a machine learning model learned to output the logit, calculate a correction value for correcting the logit using an output of the machine learning model, and
correct the logit on the basis of the calculated correction value, and estimate a class to which at least a portion of the target data corresponds on the basis of the corrected logit.

2. The estimation device according to claim 1,
wherein the processor calculates the correction value using a preset hyperparameter and an output of the machine learning model.

3. The estimation device according to claim 2,
wherein the processor calculates the correction value by a product of the hyperparameter and a prior probability of occurrence of a sample of the class, which is calculated from a marginal distribution defined by the machine learning model.

4. The estimation device according to claim 1,
wherein the processor corrects the logit by adding the correction value to the logit, and estimates a class where a probability value is maximized based on the corrected logit as the class to which at least a portion of the target data corresponds.

5. The estimation device according to claim 1,
wherein the data is an image including a plurality of pixels, and at least a portion of the data is one or more groups of pixels of the image.

6. The estimation device according to claim 1,
wherein the data is a vocal sound, and at least a portion of the data is a section of the vocal sound.

7. A vehicle control device comprising:
the estimation device according to claim 1,
wherein the processor controls traveling of a vehicle on the basis of a result of estimation by the estimation device.

8. A vehicle comprising:
the vehicle control device according to claim 7.

9. An estimation method comprising:
by a computer,
acquiring, with data as an input, a logit that at least a portion of the data corresponds to a class that represents a certain type by inputting target data to a machine learning model learned to output the logit; calculating a correction value for correcting the logit using an output of the machine learning model; and
correcting the logit on the basis of the calculated correction value; and estimating a class to which at least a portion of the target data corresponds on the basis of the corrected logit.

10. A computer-readable non-transitory storage medium that stores a program causing a computer to execute:
acquiring, with data as an input, a logit that at least a portion of the data corresponds to a class that represents a certain type by inputting target data to a machine learning model learned to output the logit, calculating a correction value for correcting the logit using an output of the machine learning model, and
correcting the logit on the basis of the calculated correction value, and estimating a class to which at least a portion of the target data corresponds on the basis of the corrected logit.
